(19) United States
(12) Patent Application Publication
(10) Pub. No.: US 2023/0011599 A1
(43) Pub. Date: Jan. 12, 2023

(54) APPARATUS AND METHOD FOR HEAT RECOVERY FROM SERVICE WATER

(71) Applicant: Schmöle GmbH, Frondenberg (DE)

(72) Inventor: Till NEUMANN, Iserlohn (DE)

(21) Appl. No.: 17/536,485

(22) Filed: Nov. 29, 2021

(30) Foreign Application Priority Data
Jul. 6, 2021 (DE) 10 2021 117 454.6

(51) Int. Cl. F28D 7/06; F28D 21/00

(52) U.S. Cl. CPC F28D 7/06; F28D 21/0012

(57) ABSTRACT

A device for heat recovery from service water, including at least one, in particular integrally materially bonded, heat-exchanger tube and a body having a substantially surface-like/laminar, in particular plate-like, region, wherein the at least one heat-exchanger tube, in particular made of copper or stainless steel, is oriented along a plane that is not orthogonal to, in particular is parallel to, the main plane of extension of the region.

According to a first aspect, the invention relates to a device for heat recovery from service water.

The significance of efficient heat management with service water, i.e. for example with shower water, is increasing in today's society for obvious reasons.

Therefore, there are first considerations, which cannot be evidenced in document form, not to let already used, heated service water or shower water simply drain into the sewer system, but instead, before this, to utilise its (residual) heat in the sense of heat recovery.

This is based on the following concept:

While very hot water (typically in the range of 60-80° C.) is mixed with completely unheated water by means of mixers in conventional showers or sinks, in particular in domestic settings, the last-mentioned, actually unheated water is also preheated in accordance with the above-mentioned considerations.

To do this, straight waste pipes are known in which the used, already heated, draining service water is conducted past the incoming, not yet heated water such that it is preheated.

The incoming, now already preheated water then makes it possible to use less of the very hot water or to use very hot water at a lower temperature in order to set a desired final temperature in the mixer or tap fitting (alternatively, the preheated water can be stored in a central tank).

In this way, a certain level of heat recovery and thus energy saving is achieved in any case.

Even though said heat-recovering waste pipes, which cannot be evidenced in document form, are certainly a first step towards heat recovery, there are of course efforts that can be made to improve the efficiency of devices of this kind.

The invention solves the stated problem according to a first aspect by means of the features of claim 1 and therefore in particular in that a corresponding device comprises at least one heat-exchanger tube and a body comprising a substantially surface-like/laminar region, wherein the heat-exchanger tube is designed not to be straight.

In particular, it is oriented along a plane that is not orthogonal to the main plane of extension of the region (but may in particular also project beyond the region in its length).

In other words, the concept of the invention is to arrange a non-straight heat-exchanger tube in a planar manner (with a planar design) under the body.

In this way, devices can be designed to be particularly space-saving.

Furthermore, in this way, particularly efficient heat recovery is achieved, since the used, already heated service water, which typically first collects above the body, can be utilised better still for preheating the actually cold fresh water in the manner of a surface heat exchanger.

Therefore, the already used service water releases its heat to the fresh water not only while draining (i.e. once it has already left the shower or sink area) for heating said fresh water, but also while it is still in the shower or sink area, in particular in the region of a drain.

In addition, by designing a device of this kind to have a particularly planar design, compatibility with existing installations to be retrofitted, for example for showers or sinks, can be achieved.

By means of the planar configuration of the device, heat-recovery effects can specifically be achieved in a simple manner in entirely conventional installation situations (for example in showers or sinks) without the building requirements needing to be modified in a complex manner.

A planar configuration of this kind even makes it possible to retrofit existing installations or systems such that they can be converted from a conventional system, which does not allow for any heat recovery, to a heat-recovering system, in particular without this being visible to a user or without this configuration being subject to an increased need for cleaning or inspection (since the used water drains away analogously to normal drains).

For example, for this purpose, a device according to the invention may be provided, in particular adhered or otherwise attached, under a conventional shower tray, shower tub, sink or the like.

Alternatively, the invention of course also covers devices which already comprise a shower tray, shower tub or the like as a body and in which the at least one heat-exchanger tube is therefore delivered as a unit together with a body of this kind (and is pre-assembled thereto where applicable).

Within the meaning of the invention, a “non-straight” design in particular means that the heat-exchanger tube has a bend, and therefore extends into a plane.

According to one configuration of the invention, at least one heat-exchanger tube is oriented along a plane that is not orthogonal or perpendicular to the main plane of extension of a surface-like/laminar region of the body. This therefore means that the heat-exchanger tube is oriented along a plane or typically extends in a plane which is not oriented orthogonally or perpendicularly to the main plane of extension of the region of the body. The planes do not form a 90° angle to one another.

The heat-exchanger tube is therefore preferably oriented along a plane, which essentially means that said plane is spanned by the direction of the greatest extension of the heat-exchanger tube and the direction of the second-greatest extension.

For example, the heat-exchanger tube may have a meandering shape or may be designed as a tube meander. If a meander of this kind is placed flat on the floor, the floor plane is approximately the plane along which the tube is oriented.

In this case, a tube meander of this kind is typically formed substantially in two planes, therefore in a planar manner.

Within the meaning of the invention, the heat-exchanger tube is preferably substantially planar, i.e. extends substantially in two-dimensional space or (only) in one plane. In other cases, however, it may have a diagonal geometry, for example.

In principle, however, the invention also covers the case in which the tube additionally also extends in a direction orthogonal to said plane. Then, however, it is crucial that the plane along which the heat-exchanger tube is oriented is the plane which is spanned by the two directions in which the entire heat-exchanger tube extends at its longest.

According to the most advantageous configuration of the invention, the heat-exchanger tube is oriented in or along a plane which is parallel to the substantially surface-like/laminar region of the body. This allows for a particularly compact construction of the device.

For example, a straight waste pipe, which leads perpendicularly away from the shower region of a shower, only extends in a plane orthogonal to the main plane of extension of the substantially surface-like/laminar region of the body and is therefore not covered by the invention.

According to the invention, it is already provided that the heat-exchanger tube is not linear or not straight.

The heat-exchanger tube may in particular be curved or may have curved portions or may at least change direction (in particular continuously).

Within the meaning of the present invention, “not orthogonal” also means that the heat-exchanger tube can be oriented along a plane which is (slightly) tilted relative to the main plane of extension of the region. Advantageously, the plane is tilted by no more than 45° relative to the main plane of extension. This also ensures that the entire device is constructed in a compact and planar manner.

According to the invention, it is provided that at least one heat-exchanger tube is provided. In principle, however, more than one heat-exchanger tube may of course also be provided, for example two or more, which may in particular be connected in series.

As a whole, the tube may have a meandering shape or a curved shape or the like.

Alternatively, a tube meander, in particular in a harp-like shape, may also be provided, which is composed of a plurality of heat-exchanger tubes.

More generally, the tube may form a tube register or a part thereof.

The heat-exchanger tube is in particular designed as a tube body, which can be considered to be a clear distinction from a channel, for example, which is e.g. formed between two plates or the like.

A tube body of this kind is typically first produced as a length of tube and is then bent into the desired final shape.

The heat-exchanger tube may be integrally materially bonded. This is intended to mean that, for example, an entire tube meander can be manufactured from a single piece, for which purpose an initially straight tube is typically bent into a meandering shape.

Of course, other shapes, such as arc shapes or harp-like shapes or the like, can also be produced instead of a meandering shape.

Typically, a heat-exchanger tube consists of copper. A different suitable material may also be selected for the tube, however, for example stainless steel or the like. Plastics tubes are also optionally not explicitly excluded by the invention.

In particular, two tubes made of different materials may be connected in series.

The heat-exchanger tube may be designed to be single-walled or multiple-walled. In particular, a single-walled tube may be combined with a multiple-walled (coaxial) tube, in particular in series.

In particular, the heat-exchanger tube may be designed as a (multiple-walled) safety tube, in order to prevent contamination of drinking water and waste water.

If a plurality of heat-exchanger tubes are provided, they are typically all arranged on the same side of the region of the body.

The region is a substantially surface-like/laminar region of a body.

The substantially surface-like/laminar region may advantageously be planar in this case. In particular, however, for example shell-like (three-dimensional) surface-like/laminar region is also covered by this description. In this sense, the region is intended to have a smooth surface.

In this case, the body may typically likewise be surface-like/laminar. The region may either form a portion of the body or the entire body.

The body may for example be a shower tray, a shower tub, a bathtub, a sink or the like, i.e. typically a unit on which service water that has already been heated is collected or spreads out and/or is conducted away. Therefore, these may be bodies for domestic settings, or may alternatively be bodies for use in public areas or even in industry. In this sense, the body may also relate to tubs or basins in machines or for machines. A body for emulsion baths in machines or the like is mentioned here by way of example. According to one configuration of the invention, a fermentation tank in a brewery or the like may be understood to be a body (which in particular demonstrates that it does not have to be planar; in this case, a heat-exchanger tube according to the invention may for example extend, three-dimensionally, over the lateral surface of a body of this kind).

The body may in particular also comprise a drain or an opening or the like.

Typically, a body of this kind generally has a substantially surface-like/laminar region in the centre or in the middle.

Within the meaning of the invention, “substantially surface-like/laminar” means that the region is designed to be more or less surface-like/laminar and would be referred to by an observer as surface-like/laminar. This definition is, however, not meant in the strictly mathematical sense, and therefore the term “substantially” has been added in order to cover slight bulges, raised portions, recessed portions or the like, for example, which nevertheless do not change the overall character of the region as being “substantially surface-like/laminar”.

The heat-exchanger tube is typically connected to the body and is designed as a unit together therewith. Therefore, the device can be sold as a pre-assembled unit. In this sense, a shower tray may for example be provided on the underside of which one or more heat-exchanger tubes are already installed.

As an alternative to a configuration of the body as a shower tray or the like, the body may also be designed merely as a mounting plate, which is in particular suitable for being mounted on, for example adhered to, one of the above-described bodies.

Therefore, within the meaning of the invention, in an embodiment of this kind, the body may be a simple mounting plate, which is sold together with the heat-exchanger tube(s) fixed thereto.

A unit of this kind can then be mounted on another body in a later work step. For example, the mounting plate may comprise an adhesive surface for this purpose (typically on the side facing away from the heat-exchanger tube), which is covered by a protective film, for example, such that said plate can be transported without any problems.

At another site, for example the installation site of a shower or sink or the like, the device according to the invention, in which the body is designed as a mounting surface, can then be adhered to or mounted on another corresponding body (such as a shower tray or a sink). This in particular makes it possible to retrofit a corresponding body (such as a shower tray or a sink or the like).

For example, a device of this kind may, however, also be adhered to a conventional tile, as is intended to be provided in the floor region of a shower, for example, or the body of the device according to the invention is itself a tile of this kind, however (and therefore the heat-exchanger tube can already be fastened to this tile in the factory or during assembly, e.g. by means of a decoupling mat).

Overall, the device therefore provides heat recovery from service water, wherein this is typically service water which is used by a user in the shower or at the sink (for example for washing up) or the like.

According to a particularly advantageous configuration of the invention, the heat-exchanger tube extends (almost) exclusively along said plane. In other words, the heat-exchanger tube does not undergo a change in direction in a third dimension, but instead changes in direction only take place in said plane (even though the tube is, by definition, of course always a three-dimensional body). Angled connection ends may for example be an exception to this, however.

Advantageously, the tube may be designed as a meander or an arc or the like, for example.

According to a particularly preferred configuration of the invention, the heat-exchanger tube abuts the region of the body and is fixed thereto. Therefore, it is in direct contact with the body.

The heat-exchanger tube can therefore fully abut the region (of the body).

This contact is in particular provided continuously in front of or over large length regions of the tube (if it is designed as a tube meander, for example, the curved portions may also project from the region, or the like).

Most preferably, the heat-exchanger tube is fixed to at least one heat-conducting element on the region.

In particular, what are known as heat-conducting plates may be provided, which can engage over portions of the tube, for example the straight portions of a tube meander, and are fastened to the substantially surface-like/laminar region by their flanges (in particular are bonded or welded thereto, or the like).

Alternatively, the heat-exchanger tube may for example be fixed to the region by a heat-conducting element which is positioned between the region and the tube, i.e. a heat-conducting element in the manner of an attachment element to which the tube is welded or the like, for example.

In particular, however, embodiments are also protected which omit a heat-conducting element and in which the tube is directly welded to the region, for example.

The heat-exchanger tube which abuts the region may in particular be a preferably rounded or geometrically optimised (flat) tube meander or a tube register, since these are particularly well suited to extensive contact with the region.

According to another particularly preferred embodiment, the heat-exchanger tube is arranged at a distance from the region.

In particular, this can be used for an embodiment in which a first heat-exchanger tube (directly) abuts the region and a second heat-exchanger tube is arranged in a (second) plane which is at a distance from the region. Therefore, in an embodiment of this kind, both heat-exchanger tubes can be arranged in parallel or in offset planes in terms of their plane of orientation.

According to the invention, it may be provided that the heat-exchanger tube is designed as a coaxial tube or a multi-channel tube (e.g. with a leakage-monitoring function).

The advantage of a configuration of this kind is that the tube can comprise two channels that are separate from one another, with one channel for the draining, used, still heated water and one channel for the incoming, not yet heated fresh water (irrespective of whether this is a coaxial tube or another tube having separate channels).

Depending on the application, a safety tube may be used for leakage monitoring.

The heat-exchanger tube may comprise at least two channels that are separate from one another, irrespective of whether this is a coaxial tube, for example provided that it comprises two channels that are arranged beside one another. Within the meaning of the present invention, tubes of this kind are advantageously also understood to be coaxial tubes.

A heat-exchanger tube of this kind may in particular function in accordance with the counterflow principle (a first fluid can flow along a first channel in the tube in a first direction and a second fluid can flow along the other channel in the tube in the opposite direction).

According to a particularly advantageous configuration of the invention, a heat-exchanger tube of this kind may in particular be designed as a siphon (e.g. on a sink or the like).

Preferably, a tube of this kind is arc-shaped and/or is arranged at a distance from the region.

In particular, a coaxial tube of this kind can be connected to a drain of the device.

According to a particularly advantageous embodiment of the invention, the heat-exchanger tube is in a meandering shape. If the heat-exchanger tube is in such a shape, it may in particular abut the region of the body.

Alternatively, the tube may for example be in an arc shape, in particular if it is arranged at a distance from the region.

According to the most preferred embodiment, both a heat-exchanger tube in a meandering shape and a (coaxial) heat-exchanger tube in an arc shape are provided, which are in particular connected in series in terms of flow.

According to the invention, it may be provided that the device comprises one heat-exchanger tube of a first type and one heat-exchanger tube of a second type. The types may differ in terms of their construction, shape, material and/or distance from the region, for example.

For example, a first tube may be provided in the form of a tube meander which abuts the region and consists of copper. Furthermore, a second heat-exchanger tube of a second type may be provided, which is for example designed as a coaxial tube and is at a distance from the region (and consists of copper or stainless steel).

These different types of tubes may in particular be connected in series in terms of flow.

A configuration of this kind makes it possible to combine different effects, namely, first of all, with regard to the first described type, the heating of the incoming water in the manner of a surface heat exchanger by means of the quantity of water collected or conducted away on the other side of the body and also additional heating of the incoming water by said water, which, however, enters and drains away on the other side of the body (namely in the coaxial tube).

Advantageously, the fresh water to be heated is first conducted through the coaxial tube in order to prevent a cooling effect on the body (e.g. the shower tray).

According to a particularly preferred embodiment of the invention, the device comprises an inlet to the heat-exchanger tube for service water. In principle, this may be the used service water or fresh water. In particular, however, this means the used service water which can reach the heat-exchanger tube from the opposite side of the region or body, in particular provided that said tube is designed as a coaxial tube.

The service water can be conducted from one side of the body to the other side of the body through the body, for example, in particular in the manner of an opening or drain, or alternatively can be conducted around the body, for example by means of a drainage channel or the like, which is then connected to the heat-exchanger tube or heat-exchanger tubes on the tube side of the body.

As already described above, the body may be designed as a sanitary body, for example in the form of a shower tray, shower tub, bathtub, sink or the like, such that the device can be sold as a “finished” product.

Alternatively, however, the body may also be designed as a carrier plate, which can be used to upgrade an existing sanitary body.

In the last-mentioned case, an adhesive layer and a protective layer covering the adhesive layer may be provided on the carrier plate.

This in particular allows for a method according to the invention in which a device of this kind in which the body is merely designed as a carrier plate, is produced at a first site (for example the supplier's assembly hall) and is then brought to a second site.

At this second site, the device can then be fastened to a separate (sanitary) body, such as a shower tray or the like. This may for example be carried out by adhesion, in particular using said adhesive layer, which is already provided on the device.

The problem addressed by the invention is also solved by a method for heat recovery from service water, according to which service water is conducted through at least one heat-exchanger tube under a body having a substantially surface-like/laminar region. This aspect of the invention is characterised in that the at least one heat-exchanger tube is oriented along a plane that is not orthogonal to the main plane of extension of the region.

At this point, it should be noted that all the advantages and features described in connection with the devices according to the invention are also intended to be transferable to the described and claimed methods, and vice versa. Merely for the sake of the clarity of the application, said advantages and features will not be repeated at this point.

It goes without saying, however, that a method is also intended to be disclosed, for example, in which the used service water is first conducted through a heat-exchanger tube of a first type and is then conducted through a heat-exchanger tube of a second type.

Other advantages of the invention become apparent from the dependent claims that have not been cited, as well as from the following description of the embodiments shown in the drawings, in which:

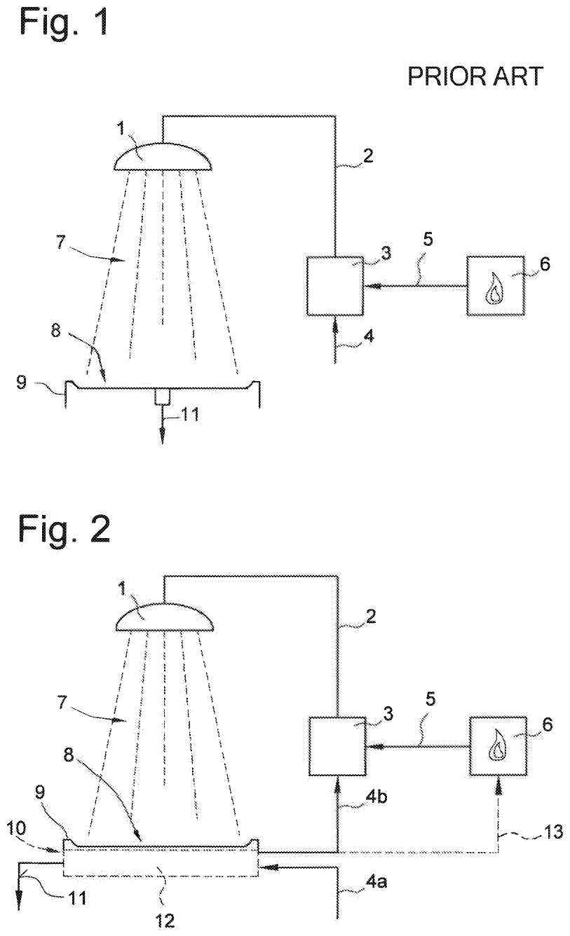

FIG. 1 is a highly schematic side view of a service water system designed as a shower, showing a shower head, a mixer, a heater and a shower tray comprising a conventional drain, this therefore being a prior-art device,

FIG. 2 is a view according to FIG. 2 of a corresponding system comprising a device according to the invention, in which a shower tray constitutes the body of the device and other elements of the device are indicated by a dashed box, with lines additionally being indicated by arrows,

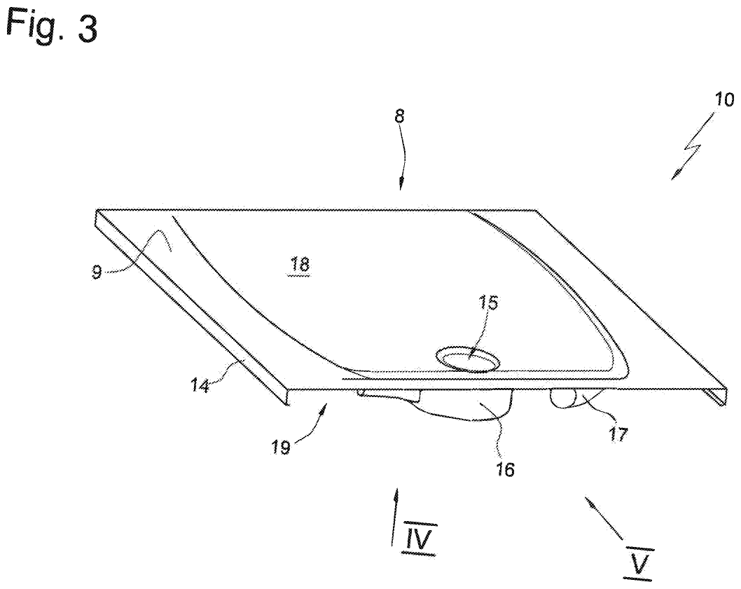

FIG. 3 is a highly schematic, isometric oblique view of a device according to the invention, in which the body is designed in the manner of a shower tray, comprising a drain and a heat-exchanger tube, which is merely indicated since it is shown as being concealed,

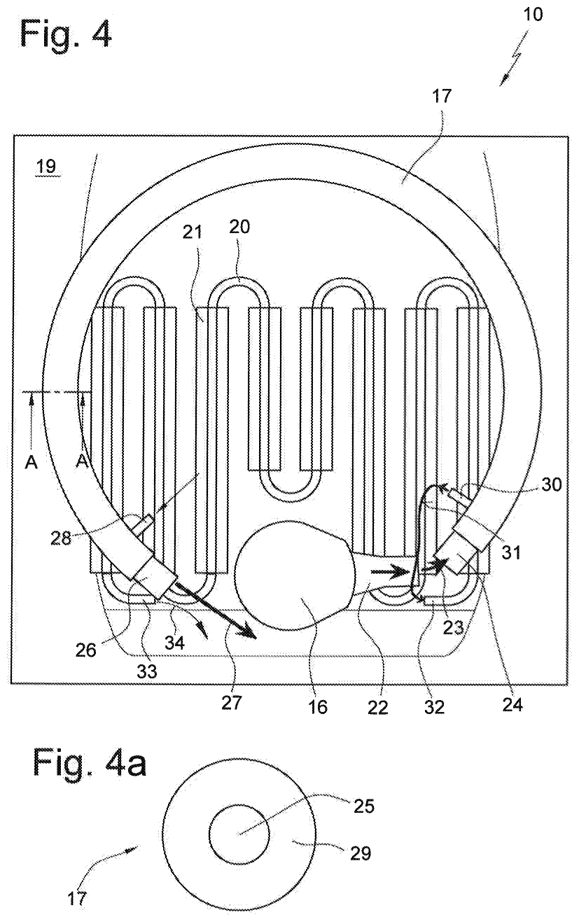

FIG. 4 is a highly schematic view from below, approximately according to arrow IV in FIG. 3, of the underside of the device according to the invention according to FIG. 3, showing a heat-exchanger tube of a first type, which is attached to the underside of the body designed as a shower tray and is designed as a tube meander, and indicating a heat-exchanger tube of a second type, which is designed as a coaxial tube in a curved shape, and additionally showing a drain, but with other connection means being omitted which would in particular connect the two heat-exchanger tubes and the drain,

FIG. 4a is a highly schematic cross section through the coaxial tube according to FIG. 4, approximately along a sectional line denoted by AA in FIG. 4,

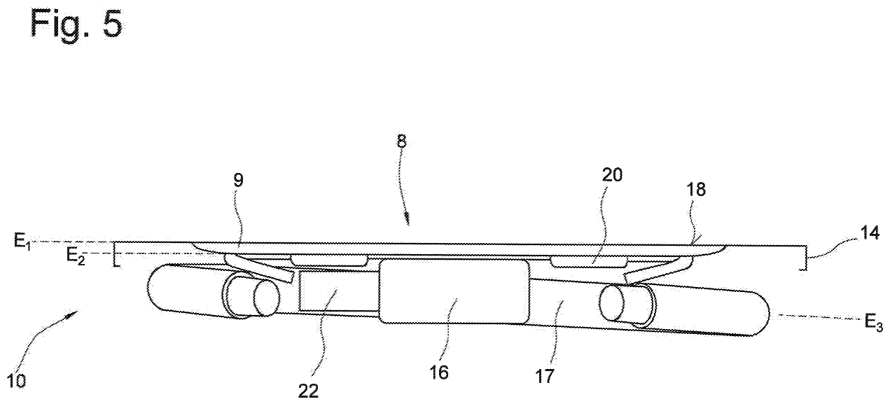

FIG. 5 is a highly schematic side view of the device according to the invention according to FIGS. 3 and 4, approximately according to arrow V in FIG. 3, showing the different planes in which the two heat-exchanger tubes are arranged,

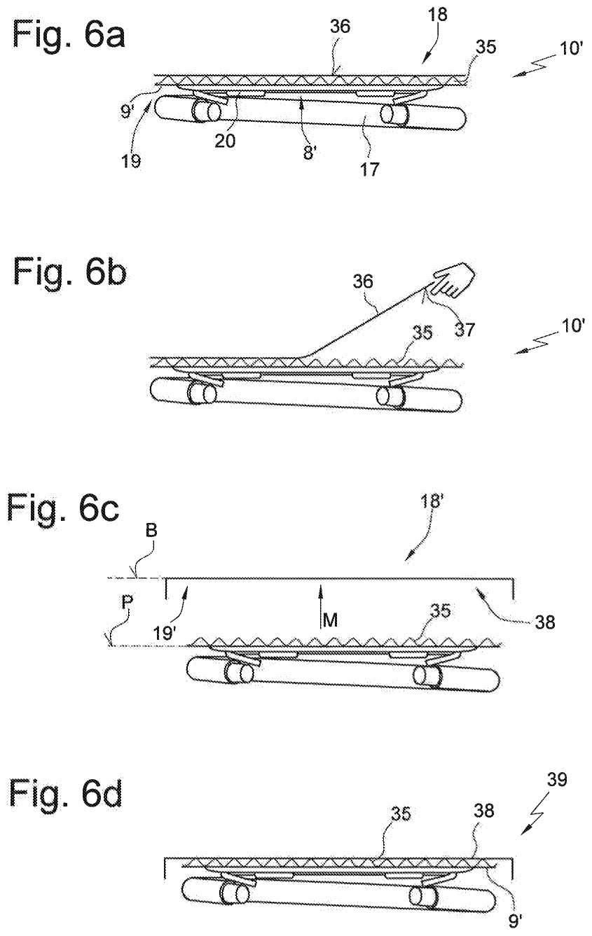

FIG. 6a is a schematic side view of a second embodiment of the invention, approximately according to FIG. 5, in which the body is designed as a carrier plate, with an adhesive layer together with a protective layer arranged thereon,

FIG. 6b is a view according to FIG. 6a of the corresponding device with the protective layer partially removed,

FIG. 6c is a corresponding view of the device according to FIG. 6b, while it is brought towards the underside of a separate body in the form of a shower tray,

FIG. 6d shows the device according to FIG. 6c together with the shower tray when completely fastened, and

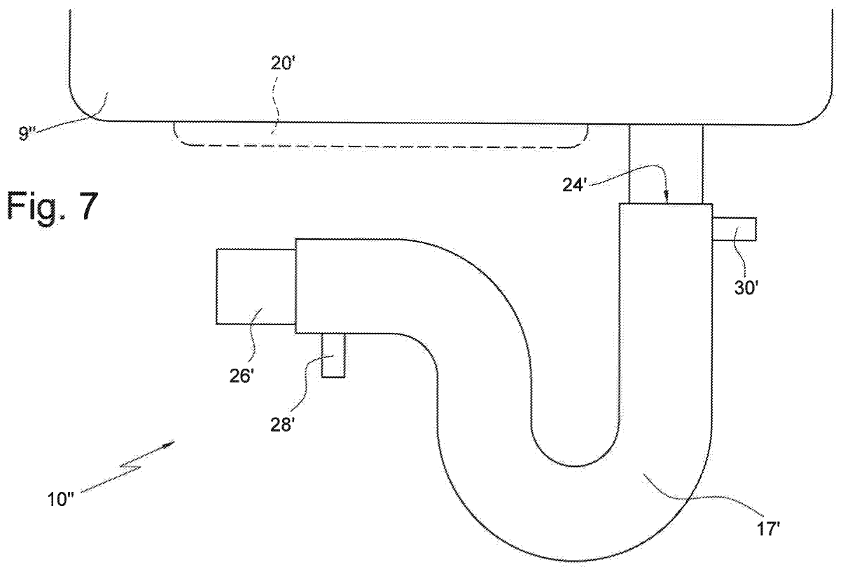

FIG. 7 is a highly schematic oblique side view of a final embodiment, in which the heat-exchanger tube is designed as a siphon of a sink and as a coaxial tube.

Embodiments of the invention are described by way of example in the following description of the figures, also with reference to the drawings. Here, for the sake of clarity, even if different embodiments are involved, identical or comparable parts or elements have been denoted by identical reference signs, sometimes with the addition of lower-case letters, numbers and/or apostrophes. The same applies to the claims following the description of the figures.

Features that are only described in relation to one embodiment can also be provided in any other embodiment of the invention within the scope of the invention. Even if they are not shown in the drawings, such amended embodiments are covered by the invention.

All the features disclosed are essential to the invention per se. The content of the disclosure of any potentially associated priority documents (copy of the previous application) and any potentially cited documents and the prior art devices described are hereby incorporated into the disclosure of the application in their entirety, also for the purpose of incorporating individual features or a plurality of features of these documents into one or more claims of the present application.

FIG. 1 first of all shows, for illustration purposes, a conventional shower system from the prior art: in this figure, a conventional shower head 1 is connected by means of a supply line 2 to a mixer 3, which is only indicated schematically. Using said mixer, a user can adjust the temperature of the water coming out of the shower head 1, in particular using a tap fitting.

Unheated fresh water is supplied to the mixer 3 via a line 4 on one hand and heated water at a high temperature, for example of 80° C., is supplied to the mixer via a line 5 on the other hand with the aid of a burner, boiler or combination boiler 6.

Once a user has set the desired water temperature using the mixer 3, they can use the service water 7 coming out of the shower head 1 at the desired temperature for cleaning, which service water 7 can then collect in the central region 8 of a shower tray 9 or drain away therethrough.

According to the system from the prior art according to FIG. 1, the used service water 7 can leave the shower tray 9 via a perpendicularly arranged soil pipe 11 without the heat still held therein being used in any way.

By contrast, the system according to the invention according to FIG. 2 shows a device 10 according to the invention for heat recovery from service water, comprising a shower tray 9 as well as additional components of the device (in particular heat-exchanger tubes) arranged under the shower tray 9, which are not shown in detail in FIG. 2, however, such that this region is merely indicated by a dashed line in FIG. 2 and is provided with reference sign 12.

As FIG. 2 shows, there is also a drain line 11 in the form of a soil pipe. The crucial difference here, however, is that the line 4, i.e. the supply line for fresh service water, is divided into a supply line 4a and an onward line 4b. The fresh service water is therefore first conducted via the supply line 4a into the region 12 and is preheated there by the used service water 7 in a manner described in greater detail below.

The then slightly preheated service water can subsequently reach the mixer 3 from the region 12 via the onward line 4b in a conventional manner and can optionally (and therefore shown by dashed lines) likewise reach the burner 6 or combination boiler via a forked onward line 13.

In this way, the system shown in FIG. 2 and the device 10 according to the invention can ensure that the mixer 3 is not only (as in the prior art) supplied with very hot and completely unheated water, but instead with very hot water (namely via the line 5) and slightly heated water (namely via the line 4b).

If the user then wants to set the same, predetermined overall temperature of 36° C., for example, in both of the systems shown, they need less of the very hot water from the line 5 in order to obtain this overall temperature according to FIG. 2.

Optionally, by means of a connection via the line 13, they need less energy in the region of the burner, boiler or combination boiler 6 in order to bring the water provided by the combination boiler 6 via the line 5 to the maximum temperature of 60-80° C. (since the water from the line 13 has already been slightly preheated).

The following figures show how this aim can be achieved.

In these figures, FIG. 3 is first of all a highly schematic, isometric oblique view of the upper side 18 of the device 10 according to the invention or of the upper side 18 of the shower tray 9 already shown in FIG. 2 or of the upper side 18 of the substantially surface-like/laminar region 8 of the shower tray 9.

The elements indicated in FIG. 2 by the box 12 also remain barely visible in FIG. 3, which is justified by the nature of an isometric view.

FIG. 3 does, however, show that the body 9 formed as a shower tray also provides rims 14 at the edges in addition to the substantially surface-like/laminar, central region 8. Said rims form the body 9 or shower tray together with the region 8.

Used service water can collect on the upper side 18 of the shower tray 9 when used as intended (in a shower), which water can then be conducted away via an opening 15 in the shower tray 9 formed as a drain. This draining, used service water then enters a discharge-like drain element 16 arranged under the region 8.

In addition to the drain element 16, FIG. 3 shows that a heat-exchanger tube 17, which is in particular designed as a coaxial tube, is also arranged on the underside 19 of the device 10 or the shower tray 9 or the region 8.

A view of FIG. 4 illustrates the components which are arranged on the underside 19 of the device 10 or the shower tray 9 or the region 8:

It thus shows that a projection 22 of the drain element 16 conducts the used service water along an arrow 23 to an inlet 24 of the coaxial tube 17.

At this point, it should be noted that, in particular in FIG. 4, but also in FIGS. 5 and 6, which are described later, and in FIG. 3, which has already been described, not all the connection elements are shown, which is in particular intended to improve the clarity of the drawings. The conducting directions and conducting paths are therefore denoted by arrows, as is routine, and corresponding line pieces, such as hoses, connectors or the like, can be designed in line with this.

In any case, the used service water is thus introduced into the coaxial tube 17 from the upper side 18 of the device 10 via the opening 15 and the end element 16, and specifically into a central channel 25, as indicated by the highly schematic section through the coaxial tube 17 shown separately in FIG. 4a.

According to the main view, FIG. 4, the coaxial tube 17 is substantially arc-shaped in this case and extends over a curve, which approximately or for example covers more than 270° of a circle. This should, however, only be understood by way of example, and the geometry can be adapted to the installation space.

The used service water can leave the coaxial tube 17 at an outlet 26 after flowing through the coaxial tube 17 and can be conducted away along the arrow 27 to the soil pipe 11 shown in FIG. 2.

The used service water can thus fulfil a special function before being drained away through the soil pipe 11 by it being able to preheat fresh, as yet unheated service water (which is supplied to the device 10 via the line denoted by 4a in FIG. 2).

This fresh, as yet unheated service water is namely conducted to an outer channel 29 (cf. FIG. 4a) of the coaxial tube 17 via an inlet 28 via the line 4a according to FIG. 2.

The initially as yet unheated fresh water thus passes through the coaxial tube 17 in a coaxial channel 29, and specifically typically counter to the conducting direction of the used service water. In this process, the used service water can partially preheat the fresh water.

In order to further heat the now preheated fresh water, the device 10 according to the invention provides another special feature:

An additional heat-exchanger tube 20 is thus provided in addition to the heat-exchanger tube 17.

The heat-exchanger tube 20 is formed as a tube meander and abuts the body 9 or the region 8 or the underside 19, in particular directly.

The tube meander 20 may in particular consist of copper and/or may comprise tube portions that are straight in some portions and curved in some portions.

In the embodiment shown, the tube meander 20 is fixed to the region 8 or the underside 19 or the body 9 by means of heat-conducting elements 21.

The heat-conducting elements 21 may for example be strip-like heat-conducting plates, which in particular engage over the straight portions of the tube meander 20 and are otherwise adhered to the underside 19 of the region 8.

In an alternative, which is not shown, the tube meander 20 could, however, also be fixed, for example firmly welded, to the region 8 by means of other heat-conducting elements or without heat-conducting elements.

The heat-exchanger tube 20 formed as a tube meander then allows for heat recovery in the following manner:

The already slightly preheated fresh water can thus leave the coaxial tube 17 via an output 30 and can be supplied to an input 32 of the tube meander 20 along an arrow 31 (via connection elements that are not shown).

The fresh water can flow through the tube meander 20 in this way and can be further heated by the used service water on the other side of the region 8 in the manner of a surface heat exchanger.

During the showering process, the shower tray 9 or the region 8 is also preheated, such that the heat stored in this body or region can also be used for further heating the fresh water conducted in the tube meander 20.

The water that has thus now been further heated can then leave the tube meander 20 at an outlet 33 and can be supplied to the line 4b (and/or 13) shown in FIG. 2 along the arrow 34 (via line means that are not shown).

Therefore, FIG. 4 thus illustrates a double stage of the heat recovery for incoming fresh water by means of two heat-exchanger tubes 17 and 20 of different types that are connected in series.

The different arrangement of the two heat-exchanger tubes 17 and 20 of different types is then illustrated in FIG. 5: this figure is a highly schematic side view of the device 10 according to the invention, approximately along arrow V in FIG. 3.

While the tube meander 20 abuts the region 8 of the shower tray 9, in particular directly, and the plane E₂ in which the tube meander 20 is oriented is thus positioned close to the main plane of extension E₁ of the region 8 and is oriented in parallel therewith, the plane E₃ along which the coaxial tube 17 is oriented is at a somewhat greater distance from the plane E₁ and the plane E₂, in particular under the region 8 or the body 9.

FIG. 5 also illustrates that the plane E₃ can also be slightly tilted relative to the main plane of extension E₁ of the region 8 where necessary, but in the present case at a tilt angle which is only a few degrees, in any case less than 45°, in particular less than 20°.

While FIG. 4 illustrates that the tube meander 20 is fastened to the body 9 by means of the heat-conducting elements 21, the views in FIGS. 4 and 5 do not specify the manner in which the coaxial tube 17 is attached to the body 9. Typically, however, providing the connection elements (not shown in FIGS. 4 and 5) in the form of tube pieces or hoses or the like is sufficient for securely and sufficiently retaining the coaxial tube 17 on the body 9. Where applicable, however, separate retaining means, such as adhesive strips or fastening bars or the like, may of course also be provided, but are not shown in the drawings, since they are optional. This may in particular be a heat-insulating matrix.

FIG. 6a then shows another embodiment of a device 10′ according to the invention, approximately in a view according to FIG. 5.

Here, FIG. 6a first illustrates that, according to this embodiment, the body 9′ is not designed as a sanitary body, such as a shower tray or the like, but as a conventional carrier plate.

In other words, the components, such as the coaxial tube 17 or the tube meander 20, are not directly arranged on a sanitary body, but instead are arranged on a carrier plate 9′, in particular on the surface-like/laminar region 8′ thereof.

An adhesive layer 35 is arranged on the upper side 18 of the carrier plate 9′, which layer is covered by a protective layer 36, in particular over its entire surface. The protective layer 36 is used in particular to make it easier to handle and transport the device 10′ in the sense that the device 10′ does not adhere to another object during transport due to the adhesive layer 35.

The device 10′ shown in FIG. 6b is then already at a second site, wherein this may possibly be the installation site, for example, i.e. the building room in which a shower, sink, bathtub or the like is attached or is intended to be attached, for example.

Alternatively, the finished device 10′ may first be transported from the locality of the manufacturer to a locality of an installer which is in the vicinity of the installation site.

In any case, according to FIG. 6b, the protective layer or protective film 36 can be easily manually removed or peeled off at a second site, which is advantageously the installation site. In this way, the adhesive layer 35 of the device 10′ is exposed. To do this, a user can grip a grip face 37 of the protective layer 36 from behind with their hand.

According to FIG. 6b, the protective layer 36 is preferably removed immediately before the device 10′ is adhered in or on a second body 38, which may be designed as a shower tray, sink, bathtub or the like, for example.

When the protective layer 36 is peeled off according to FIG. 6c, the device 10′, in particular comprising the exposed adhesive layer 35, can be brought closer to the underside 19′ of the second body 38 in a mounting direction M and can be adhered thereto, in particular over its entire surface, by means of the exposed adhesive layer 35. In this case, this adhesion takes place in a substantially plane parallel manner by the plate plane P being brought towards the fastening plane B of the second body 38 in a plane parallel manner until it adheres to the underside 19′ thereof.

No tools, aids or the like are generally required for this purpose. A user can do this manually, in particular by exerting pressure on the carrier plate 9′ approximately in the mounting direction M after placing the device 10′ onto the underside 19′ of the second body 38.

A completed, retrofitted product is then provided with reference sign 39 in FIG. 6d.

This product 39 can then be installed as a whole.

With regard to the sequence of figures in FIG. 6, it should be noted that, for example, a drain element 16 is not provided here, as is shown in the preceding figures, in order to increase the number of possible uses of the device 10′.

Alternatively, however, a corresponding drain element 16 could of course be provided if a corresponding opening 15 were provided in the carrier plate 9′ and the carrier plate were then arranged on a second body 38 comprising a congruent opening.

If a drain element 16 is not provided, the used service water that is actually on the upper side 18′ can flow into the tubes 17 and 20 at the sides, for example, in particular via an outlet channel or shower channel (not shown).

Lastly, FIG. 7 shows a final embodiment of the invention comprising a device 10″ in which the heat-exchanger tube 17 is designed as a siphon. By way of example, the siphon 17′ is connected to a body 9″ designed as a sink, wherein the siphon is designed as a coaxial tube and has a cross section according to FIG. 4a, i.e. also comprising two channels 25 and 29, which are not shown in FIG. 7, however.

Analogously to the embodiment according to FIG. 4, the draining water from the sink 9″ can enter the central channel 25 of the siphon 17′ via an inlet 24′ and can leave said channel again at an outlet 26′. Analogously to the embodiment according to FIG. 4, the freshly incoming water can enter the coaxial tube 17′ at an inlet 28′, namely in an outer channel 29, and can pass through the tube 17′ in the opposite direction to the used dishwater and leave said tube at an output 30′. The previously heated water can be supplied to a tap fitting or a burner or the like as already preheated water, analogously to the above embodiments.

Alternatively, and as shown by dashed lines in FIG. 7, in this embodiment, said water can, however, also be conducted further in a second heat-exchanger tube 20′ in the form of a heat-exchanger tube abutting the body 9″ or the surface-like/laminar region thereof. For example, this heat-exchanger tube may be designed as a tube meander. In this case, said additional heat-exchanger tube 20′ assumes a function, for example in accordance with the heat-exchanger tube 20 according to the preceding embodiments, such that the water can be further heated before it is then likewise conducted further to the tap fitting and/or a burner.

1-12. (canceled)

13. A device for heat recovery from service water, comprising: at least one heat-exchanger tube; and a body having a substantially surface-like/laminar region, wherein the at least one heat-exchanger tube is configured not to be straight.

14. The device according to claim 13, wherein the at least one heat-exchanger tube is oriented along a plane that is not orthogonal to, preferably is parallel to or only slightly tilted relative to, a main plane of extension of the region.

15. The device according to claim 14, wherein the at least one heat-exchanger tube is parallel to or only slightly tilted relative to the main plane of extension of the region.

16. The device according to claim 14, wherein the heat-exchanger tube extends exclusively along said plane.

17. The device according to claim 13, wherein the heat-exchanger tube abuts the region and is fixed thereto.

18. The device according to claim 17, wherein the heat-exchanger tube directly abuts the region and is fixed to the region by at least one heat-conducting element.

19. The device according to claim 13, wherein the heat-exchanger tube is a coaxial tube or a multi-channel tube comprising two channels that are separate from one another.

20. The device according to claim 19, wherein the two channels include one channel for fresh service water to be heated and one channel for service water that has already been used and heated.

21. The device according to claim 13, wherein the heat-exchanger tube is in a meandering shape or an arc shape.

22. The device according to claim 13, wherein the at least one heat-exchanger tube includes a heat-exchanger tube of a first type and a heat-exchanger tube of a second type that are connected in series in terms of flow.

23. The device according to claim 22, wherein the heat-exchanger tube of a first type is a tube meander and/or a tube abutting the region, and the heat-exchanger tube of a second type is a coaxial tube and/or a tube at a distance from the region.

24. The device according to claim 13, further comprising an inlet to the heat-exchanger tube for used service water, which reaches the heat-exchanger tube from an opposite side of the region through an opening in the region.

25. The device according to claim 13, wherein the body is a shower tray, a tub or a sink.

26. The device according to claim 13, wherein the body is a carrier plate having side of which facing away from the heat-exchanger tube, an adhesive layer being arranged on the side facing away from the heat-exchanger tube, and an outer protective layer being arranged to removably cover the adhesive layer.

27. The device according to claim 13, wherein the heat-exchanger tube is a siphon.

28. The device according to claim 13, wherein the heat-exchanger tube is made of copper or stainless steel.

29. The device according to claim 13, wherein the heat-exchanger tube is integrally and materially bonded.

30. A method for producing an installation for heat recovery from service water, comprising: producing a device according to claim 26 at a first site; and taking the device to a second site, at which the device is fastened to the separate body.

31. A method for heat recovery from service water, in particular using a device according to claim 13, comprising the steps of: providing at least one heat-exchanger tube configured not to be straight; arranging the at least one heat-exchanger tube under a body having a substantially surface-like/laminar region; and conducting service water through the at least one heat-exchanger tube.

32. the method according to claim 31, including orienting the at least one heat-exchanger tube along a plane that is not orthogonal to a main plane of extension of the region.
